(19) United States
(12) Patent Application Publication
(10) Pub. No.: US 2004/0063804 A1
(43) Pub. Date: Apr. 1, 2004

(54) Thermosetting adhesive

(76) Inventors: Masaaki Takeda, Kanagawa (JP); Kohichiro Kawate, Tokyo (JP); Shigeyoshi Ishii, Kanagawa pref (JP); Naoyuki Toriumi, Kanagawa pref (JP); Koji Itoh, Kanagawa pref (JP); Tomihiro Hara, Kanagawa pref (JP)

Correspondence Address: 3M INNOVATIVE PROPERTIES COMPANY, P.O. BOX 33427, ST. PAUL, MN, 55133-3427, US

(21) Appl. No.: 10/470,875

(22) PCT Filed: Mar. 21, 2002
(86) PCT No.: PCT/US02/08802

(30) Foreign Application Priority Data
Mar. 30, 2001 (JP) 2001-100609

(51) Int. Cl. C08J 3/28; C08K 3/22; C08L 63/00

(52) U.S. Cl. 522/122; 524/430; 523/457

(57) ABSTRACT

A thermosetting adhesive which produces no foul odor or discharged gas, or form no bubbles under irradiation, and which exhibits a satisfactorily high bonding property, even under low-dose irradiation. The thermosetting adhesive contains an ethylene-glycidyl (meth)acrylate copolymer, whose principal monomer components are an ethylene and a glycidyl (meth)acrylate, and a sulphonium salt-comprising cationic polymerization catalyst.

### FIELD OF THE INVENTION

The present invention relates to an adhesive containing a thermosetting resin, hereinafter referred to as “thermosetting adhesive”.

### DESCRIPTION OF THE RELATED ART

Thermosetting adhesives can form three-dimensional crosslinked structure (also known as “network structure” or “bridged structure”), with an application of heat. The thermosetting adhesives typically contain an epoxy resin as a thermosetting resin. The thermosetting resins form crosslinked structure between molecules of the epoxy resins and exhibit mechanical properties, heat resistance and weather resistance, as well as excellent adhesive strength.

Among the known thermosetting adhesives which contain epoxy resins are reactive hot-melt adhesives. The reactive hot-melt adhesives are heat-pressed on a substrate and exposed to heat or light, to cross link the epoxy resin and to cure, thus resulting in excellent bonding power having superior heat resistance, etc.

A typical reactive hot-melt adhesive is disclosed in Japanese Patent Application Laid-Open No. 10-316955. This reactive hot-melt adhesive contains a thermosetting resin which comprises a polyethylene polymer having an epoxy component therein. The adhesive is chemically stable and advantageously uses for bonding electronic components to substrates, during IC (integrated circuit) mounting processes.

The reactive hot-melt adhesive is generally irradiated with radiation, such as electron ray, to form some crosslinked structure between ethylene units of the thermosetting resin, which reduces flowability, and prevents any oozing which may occur during heat-pressing. However, the irradiation to the adhesive gives rise to cleavage of main chain or side chain of the thermosetting resin in some degree and generates ions with low boiling point and volatile substances, which causes foul odor and discharged gas. Moreover, the radiation is converted to thermal energy, which causes bubbles to form in the reactive hot-melt adhesive. Such bubbles are particularly undesirable in film adhesives comprising a reactive hot-melt adhesive formed on a liner. This is because they deteriorate the appearance of the object which has been irradiated, whether it is a reactive hot-melt adhesive or a film adhesive, as well as reduces adhesive strength.

The cleavage of the main or side chains of the thermosetting resin and the conversion to thermal energy may be prevented by adding a so-called electron beam sensitizer to the reactive hot-melt adhesive. When the electron beam sensitizer is triallyl cyanurate (TAC), triallyl isocyanurate (TAIC) or trimethylolpropane trimethacrylate (TMPTMA), it increases the reactivity of the vinyl groups and meth(acrylate) groups which are present, thus enhancing degree of crosslinking. Thus, it is expected that bubbles will not form and flowability will decrease, even at relatively low doses of radiation. However, a decrease in flowability is difficult, even at relatively low doses of radiation. Moreover, even if the flowability of the reactive hot-melt adhesive is able to be reduced through relatively low doses of radiation, adhesive strength would still decrease.

It is therefore an object of the present invention to provide a reactive hot-melt thermosetting adhesive which can impart desirable adhesive properties for bonding electronic components to substrates, even if the adhesive is cured using a reduced dose of e.g. electron irradiation.

### SUMMARY OF THE INVENTION

The present invention provides a thermosetting adhesive, which comprises an ethylene-glycidyl (meth)acrylate copolymer, formed from monomers mainly composed of ethylene and glycidyl (meth)acrylate, and a cationic polymerization catalyst comprising a sulphonium salt expressed by the formula below:

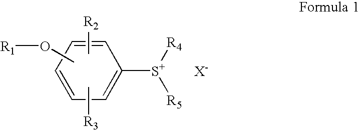

(wherein —OR₁ is present at 2, 4 or 6 position of the phenyl group, R₁ represents an acetyl group, a methoxycarbonyl group, an ethoxycarbonyl group, a benzyloxycarbonyl group, a benzoyl group, a phenoxycarbonyl group, a p-methoxybenzyloxycarbonyl group or a 9-fluorenylmethoxycarbonyl group; R₂ and R₃ independently show hydrogen, halogen or an alkyl group having 1 to 4 carbon atoms; R₄ and R₅ independently show an alkyl group having 1 to 4 carbon atoms, and X⁻ shows a non-nucleophilic anion).

### DETAILED DESCRIPTION

The thermosetting adhesive composition (described hereinafter simply as “adhesive composition”) of the present invention imparts desirable adhesive properties for bonding electronic components to substrates, even if the adhesive is cured at a reduced dose of e.g. electron radiation, and as shall be described in detail, is composed of the following components.

The thermosetting adhesive composition of the present invention contains at least one ethylene-glycidyl (meth)acrylate copolymer (referred to as “glycidyl (meth)acrylate copolymer”). The glycidyl (meth)acrylate copolymer is a thermosetting resin which is based on a polyethylene having a low dielectric constant, excellent chemical stability and water resistance, and which contains within the molecules an epoxy group derived from a glycidyl group. A content of this resin in the adhesive composition is generally 10 to 95 wt %, preferably 30 to 88 wt % and more preferably 40 to 85 wt %.

Since the glycidyl (meth)acrylate copolymer does not separate epoxy components even in the heat-pressing process described hereinafter; the production of any discharged gas does not occur. Moreover, the adhesive composition melts at a relatively low temperatures and is thus advantageously applied in melt coating. By melting the adhesive composition as described above to form a secure bond with an object, then allowing it to cool and solidify, the adhesion with the object can be effected, owing to good heat adhesive ability of the composition. The glycidyl (meth)acrylate copolymer, when irradiated with electron beam, can form crosslinked structure between the ethylene units.

The crosslinked structure is advantageous in improving an elastic modulus of the adhesive composition during heat-pressing. Heating the glycidyl (meth)acrylate copolymer at a predetermined temperature, moreover, will cause it to react with the cationic polymerization catalyst, to form crosslinked structure between its units and to cure, thereby increasing the cohesive strength of the adhesive composition. The high cohesive strength is advantageous in imparting exceptional peeling adhesive strength and other adhesive properties to the adhesive composition.

The glycidyl (meth)acrylate copolymer is preferably a binary polymer formed from a monomer mixture which comprises an ethylene and a glycidyl (meth)acrylate. A weight ratio (E:G) of ethylene (E) and glycidyl (meth)acrylate (G) is preferably 50:50 to 99:1 and more preferably 80:20 to 95:5. Lesser amounts of ethylene in the monomer mixture for the glycidyl (meth)acrylate copolymer, will promote reaction with the cationic polymerization catalyst during its manufacture. Such an adhesive composition would be difficult to use in practical applications. The resulting adhesive composition has poor storage stability, when it is irradiated with electron beam. On the other hand, if an amount of ethylene is more in the monomer mixture for the glycidyl (meth)acrylate copolymer, the composition has poor adhesive performance.

Another monomer can be added to the monomer mixture for the glycidyl (meth)acrylate copolymer, as long as the technical effects of the present invention are not sacrificed. Examples of the other monomers are propylene, vinyl acetate, and alkyl (meth)acrylate (with the alkyl group generally containing 1 to 8 carbon atoms), whereby a terpolymer such as glycidyl (meth)acrylate-vinyl acetate-ethylene or glycidyl (meth)acrylate-ethylene-alkyl (meth)acrylate and the like can be formed. The terpolymer may generally contain the two monomers (ethylene units and glycidyl (meth)acrylate units) in an amount of at least 50 wt %, and preferably at least 75 wt %, based on the total monomer content, provided that the adhesive strength can be increased to the desired range without causing a marked reduction in the rate of reaction during heat curing.

A weight average molecular weight of the glycidyl (meth)acrylate copolymer is selected so as generally to allow a melt flow rate (MFR) of at least 1 (g/10 min) or preferably at least 150 (g/10 min) at 190° C. Within these ranges, the adhesive composition can have advantageous melt coatability and heat adhesive ability. On the other hand, the high MFR decreases cohesive strength of the cured adhesive composition and therefore an MFR of 200 to 1000 (g/10 min) is preferable. In the present specification, the MFR is measured according to JIS K 6760.

According to the present invention, the adhesive composition contains a sulphonium salt-comprised cationic polymerization catalyst. The sulphonium salt is expressed by the formula below.

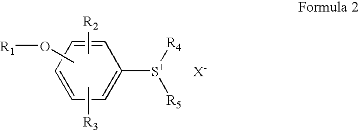

In the formula, —OR¹ is in a 2, 4 or 6 position of the phenyl group, with the 4 position being preferred because it is produced more stable. R₁ is acetyl group, methoxycarbonyl group, ethoxycarbonyl group, benzyloxycarbonyl group, benzoyl group, phenoxycarbonyl group, p-methoxybenzyloxycarbonyl group or 9-fluorenylmethoxycarbonyl group. R₂ and R₃ independently show hydrogen, halogen or an alkyl group with 1 to 4 carbon atoms and occupy any of the 2 to 6 positions of phenyl groups in which no —OR¹ is present. R₄ and R₅ independently show an alkyl group having 1 to 4 carbon atoms. X⁻ is a non-nucleophilic anion.

The non-nucleophilic anion of the sulphonium salt of the present invention preferably has an anion radius of more than about 0.254 nm. This is because the larger the anion radius of the sulphonium salt, the lower the temperature of heat curing and the shorter the time of heat curing.

Examples of the non-nucleophilic anion of the present invention are SbF₆⁻ AsF₆⁻ or PF₆⁻. In addition, aryl borate anion, fluorocarbon anion and imido anion can also be included, with the fluorocarbon anion and imido anion being described in U.S. Pat. No. 5,554,664. The aryl borate anion includes tetrakis (pentafluorophenyl) borate. The fluorocarbon anion includes C(SO₂CF₃)₃⁻ and the imido anion includes (C₂F₆SO₂)₂N⁻.

The sulphonium salt as cationic polymerization catalyst is latent; exhibiting high activity when heated, which can facilitate the formation of crosslinked structure between the glycidyl (meth)acrylate units of the glycidyl (meth)acrylate copolymer. Accordingly, the elastic modulus of the adhesive composition can be raised to a desired level in a relatively short period after being heated. The high elastic modulus can result in enhanced solder heat resistance during solder reflow, which is one of the processes involved in the manufacture of integrated circuits. Solder heat resistance is a critical property required for adhesive compositions used in electronic components bonding, IC package fabrication and the like.

On the other hand, the cationic polymerization catalyst does not tend to produce Brönsted acid (hydrogen ions) under excitation, even under electron beam irradiation as described in the above. Even if the electron irradiation stops, the Brönsted acid attacks epoxy groups in the glycidyl (meth)acrylate copolymer, and such dark reactions, in which bridge structure formation is prompted by cationic polymerization, tend not to progress at ambient temperatures (room temperature of approximately 25° C.) in dark places. Accordingly, the adhesive composition of the present invention not only possesses exceptional storage stability and a long shelf life, even after being subjected to electron irradiation, but can be satisfactorily heat-pressing bonded to objects, while the desired flowability is maintained.

The cationic polymerization catalyst has considerable utility in that reduced flowability results from the crosslinked structure being effectively established between the ethylene units of the glycidyl (meth)acrylate copolymer. This is due to the fact that when the adhesive composition contains the cationic polymerization catalyst, the composition obtains desirable flowability when applied, even at electron beam irradiation of 10 to 200 kGy. Accordingly, oozing which occurs during heat-pressing is effectively prevented, and provides excellent appearance on e.g. electronic components when bonded. In addition, there is little occurrence of conversion of radiation to thermal energy, and occurrence of bubbles in the adhesive composition. Accordingly, there is virtually no incidence of adversely affected appearance or adhesive strength. Also, the use of reduced-dose radiation eliminates both partial cleavage of the main or side chains of the thermosetting resin and the formation of low-boiling ions and volatile substances, which cause foul odor and discharged gas.

The adhesive composition generally contains 0.001 to 1 wt % of the cationic polymerization catalyst. A content of less than 0.001 wt % will result in the reaction rate during heat curing being excessively slow, which tends to an inadequate heat cure, while a content of greater than 1 wt % will result in gelling during the manufacturing process and the reaction proceeding too much under electron irradiation, which will prevent satisfactory heat-pressing. It is preferable for the cationic polymerization catalyst content in the adhesive composition to be 0.001 to 0.5 wt %, in consideration of preventing ions contained in any impurities from corroding the ICs etc., and from having an effect on adhesive strength.

According to the present invention, 4-acetoxyphenyl dimethylsulphonium hexafluoroantimonate or 4-[(methoxycarbonyl)oxy]benzenedimethylsulfonium hexafluoroantimonate is preferably used as the cationic polymerization catalyst. This is because stability is high due to high initial reaction temperature during the manufacturing process, and the catalyst is activated following electron beam irradiation, which allows heat curing to be accomplished in a short period of time.

The cationic polymerization catalyst sulphonium salt is generally obtained as follows. A sulphonium salt containing methyl sulphate ion is synthesized by reacting a corresponding 4-(substituted oxyphenyl alkyl sulphide) with an alkyl sulphate. Next, it is subjected to anion exchange with a predetermined complex salt, to obtain a desired sulphonium salt at a high yield. Alternatively, a sulphonium salt is commercially available from Sanshin Kagaku Kogyo (KK), as described subsequently in the examples, instead of being manufactured as described in the above.

The adhesive composition of the present invention as described in the above can be used in the form of a reactive, hot-melt film adhesive. This film adhesive is preferably 0.001 to 5 mm thick and more preferably 0.005 to 0.5 mm thick, owing to ease of handling and high reliability derived from the uniform crosslinked structure established in its thickness direction.

The film adhesives are manufactured according to the following method. First, the adhesive composition is melt-coated onto a substrate, typically at 60° C. to 120° C. The adhesive composition is typically prepared by kneading or mixing the components until they have assumed an essentially uniform state. Kneaders, roll mills, extruders, planetary mixers, homomixers and the like can generally be used for the kneading or mixing processes. In this context, it is important for temperature and time to be adjusted in such circumstances that the ethylene-glycidyl (meth)acrylate copolymer does not substantially react with the sulphonium salt. Generally, a complex elastic modulus η* of the adhesive composition is preferably controlled to a range of 500 to 1,000,000 poise and even more preferably to a range of 1,200 to 10,000 poise, by keeping the temperature and time within 20 to 120° C. and 1 minute to 2 hours, respectively. This ensures that the adhesive composition is shaped into a film of the desired thickness through continuous coating. In the present specification, the complex elastic modulus η* is a value determined under conditions of 120° and an angular velocity of 6.28 rad/sec.

The substrate includes a liner such as a release sheet or release film, or other object to be bonded. The melt coating process can be conducted by a knife coater, die coater, or other common coating means.

The film adhesive is obtained by subjecting the adhesive composition to electron irradiation, to form a crosslinked structure between the ethylene units of the glycidyl (meth)acrylate copolymer. According to the present invention, electron beam is accelerated at a voltage of 150 to 500 keV and directed onto the adhesive composition, while the absorbed dose is reduced to between 10 to 200 kGy, as described above. The resulting film adhesive has a desirable appearance, and free of bubbles. The film adhesive contain virtually no low-boiling point monomers or volatile substances, which can cause foul odors and gas discharge. The film adhesive can be made into a final product by protecting its adhesive surface with a liner. The film adhesive may also be made into a final product without a protective liner, if the pressure sensitive adhesion of the adhesive surface is relatively low.

An example of an application of the film adhesive shall be described. First, as necessary, the liner is removed from the film adhesive, after which the adhesive is sandwiched between a first object to be bonded and a second object to be bonded. Next, the laminated body is heat-pressed at a pressure of 0.1 to 100 kg/cm² and 80° C. to 300° C. to obtain a bonded structure comprising the first object to be bonded being tightly bonded to the second object to be bonded. Since no bubbles will be present in the film adhesive, adhesive strength will not decrease.

According to the above method, the film adhesive can provide an adhesive strength for a relatively short period of time of 0.1 to 30 sec which is exceptional in its solder heat resistance between the two objects to be bonded, while the elastic modulus is increased. Accordingly, the film adhesive is desirable in processes for manufacturing integrated circuits, which involves wire bonding. It is also preferable from an environmental standpoint, as no solvents are employed.

Therefore, the film adhesive can provide sufficient adhesive strength even without heat-pressing; but its adhesive strength can increase to 4 to 15 kg/25 mm and higher by performing a post-curing process. The bonding structure is heated from 1 min to 24 hours, generally at 120° C. or higher, and preferably at between 130 to 300° C. so as to reduce the time required for the post-curing process. Specifically, by heating the bonding structure at 140 to 200° C., the post-curing time can be shortened to 30 min and 12 hours.

The thermosetting adhesive composition may additionally contain an ethylene-alkyl (meth)acrylate copolymer (hereinafter referred to as “alkyl (meth)acrylate copolymer”). In particular, the content of the alkyl (meth)acrylate copolymer in the thermosetting adhesive composition lies generally within the range of 4 to 80 wt %, preferably 10 to 60 wt % and more preferably 15 to 50 wt %, so as to provide the thermosetting adhesive composition with the desired melt coatability, heat adhesive ability, crosslinkability from electron irradiation and post-curability.

The alkyl (meth)acrylate copolymer has a lower water absorbency than the glycidyl (meth)acrylate copolymer, which enables it to impart water-resistance to the thermosetting adhesive composition and the film adhesive thereof. Moreover, the alkyl (meth)acrylate copolymer generally has a lower softening point than the glycidyl (meth)acrylate copolymer. This enables internal stresses to be alleviated and adhesive performance to increase, even if the thermosetting adhesive composition and the film adhesive thereof receive heat cycle after curing.

The alkyl (meth)acrylate copolymer allows the adhesive composition to melt at a relatively low temperature, similar to the glycidyl (meth)acrylate copolymer, and therefore the heat adhesive ability of the adhesive composition can be increased. Moreover, irradiating the alkyl (meth)acrylate copolymer with electron rays enables a crosslinked structure to be formed between other alkyl (meth)acrylate copolymers or glycidyl (meth)acrylate copolymers via the ethylene units. The crosslinked structure is, as described above, advantageous from the perspective of increasing elastic modulus during heat-pressing of the adhesive composition.

The alkyl (meth)acrylate copolymer is a copolymer which comprises monomer mixture which essentially contains an alkyl (meth)acrylate monomer and ethylene. In this case, it is desirable that the alkyl(math)acrylate has alkyl group having 1 to 4 carbon atoms, because the adhesive composition does not increase elastic modulus after crosslinking if the alkyl group contain more than 4 carbon atoms. A weight ratio (E:G) between ethylene (E) and glycidyl (meth)acrylate (G) is preferably within the range of 60:40 to 1:99, and more preferably 50:50 to 5:95. If the alkyl (meth)acrylate copolymer contains smaller amount of ethylene, the adhesive composition does not have increased elastic modulus even if it is irradiated with electron beam to form crosslinked structure. On the other hand, if the copolymer contains more ethylene, the adhesive composition has reduced adhesive performance.

A third copolymerizable monomer may be used in addition to the monomer components, to constitute a ternary alkyl (meth)acrylate copolymer, provided that the merits of the present invention are not sacrificed. In these circumstances, the third copolymerizable monomer should contain no epoxy groups, similar to propylenes and vinyl acetates. From the perspectives of adhesive strength, rate of reaction during heat curing, and the like, the content of the binary copolymer structural units (ethylene units and glycidyl (meth)acrylates) in the ternary alkyl (meth)acrylate copolymer should generally be at least 50 wt % and preferably at least 75 wt %. The third polymerizable monomer may contain carboxyl groups or carboxylic anhydride functional groups, as long as the heat curing reaction between the (meth)acrylate copolymers and the glycidyl (meth)acrylate copolymers is suppressed, to enable any gelling or undesirable increases in viscosity to be very easily avoided while the adhesive composition is being shaped into a desired form, such as a film.

The weight average molecular weight of the alkyl (meth)acrylate copolymer is selected to obtain an MFR at 190° C. of at least 1 (g/10 min) and preferably 150 (g/10 min) similar to the glycidyl (meth)acrylate copolymer, and therefore the adhesive composition has melt coatability and heat adhesive ability.

When the thermosetting adhesive composition contains the alkyl (meth)acrylate copolymer described above, it can be prepared by kneading or mixing, as shall be described below. First, the alkyl (meth)acrylate copolymer is uniformly mixed with rosin at 60 to 200° C. for 10 sec to 2 hours to form pellets.

Next, the pellets are generally mixed with the remaining components which include the glycidyl (meth)acrylate copolymer, for from 10 seconds to 2 hours at 90° C. to 120° C., to form an adhesive composition in which all of the components have been uniformly blended. By the term “pellets”, small clusters of definite or indefinite shape are meant. The pellets are formed, for example, by mixing the predetermined components together to obtain a relatively large cluster, pulverising same in a kneading apparatus, and then using a pelletizer or granulator on the resulting mixture of the predetermined components. In the above case, the small cluster generally has a volume of 0.001 to 1,000 mm³.

The adhesive composition of the present invention may contain rosin that contains carboxyl groups within the molecules, in a content range of 1 to 20 wt %, preferably 2 to 15 wt %, more preferably 3 to 10 wt %, provided that the effects and merits of the invention are not sacrificed. In these circumstances, heating the rosin together with the glycidyl (meth)acrylate copolymer will not cause any decrease in heat adhesive ability, and the cohesive strength of the adhesive composition can be increased after it cures by incorporating the rosin in the crosslinked structure between the glycidyl (meth)acrylate units in the glycidyl (meth)acrylate copolymer. A high cohesive strength is advantageous in adhesives having good adhesion for peeling adhesive strength and the like.

The rosin is not particularly limited in the present invention provided that the effect and merits of the invention are not sacrificed; however, in consideration of the crosslinking reaction with the glycidyl (meth)acrylate copolymer and the stability when the adhesive composition is heated and shaped (the effect of preventing an increase in viscosity), the rosin should preferably have an acid value of 100 to 300, more preferably of 150 to 250. In addition, if the rosin has a softening point of 50 to 200° C., more preferably 70 to 150° C., then it can provide a desired storage stability to the adhesive composition. Examples of the rosins include rubber rosin, wood or tall oil rosin, or chemically modified rosin (e.g., polymerized rosin). The rosin can be used singly or in mixtures of two or more. Moreover, they can be used with other rosins which contain no carboxyl groups, provided that the effect and merits of the present invention are not sacrificed.

If the amount of sulphonium salt to be added is small, it can be dissolved in a reactive diluent such as γ-butyrolactone. However, the addition of large amounts of the reactive diluent may cause gas to be produced and discharged during heat-pressing, which causes poor adhesive ability. It is therefore preferred that the reactive diluent contains an amount of no more than 1 wt % sulfonium. Low-boiling point reactive diluents are equally undesirable for similar reasons.

Antioxidants, UV absorbing agents, fillers (inorganic fillers, electrically conductive particles, pigments, etc.), wax or other slip additives, rubber components, tackifiers, crosslinking agents, curing promoters and the like may be additionally blended with the thermosetting adhesive composition, provided that the effect and merits of the invention are not sacrificed.

The film adhesive can be manufactured by extruding the adhesive composition to form a film, rather than using melt coating to form a film on a substrate. In this case, the film adhesive can be manufactured without a substrate. Alternatively, if either of the first or second object to be bonded is penetrable by e.g. electron irradiation or the like, the adhesive composition can be applied directly on to the surface thereof. In this case, the film adhesive can be obviated; instead, a bonded structure can be obtained between the adhesive composition and the given substrate on which it has been coated by means of the electron irradiation thereupon.

### EXAMPLES

The present invention shall be described in further detail below according to examples; however, the present invention shall not be limited to these examples.

### 1. Fabrication of Film Adhesive

Compositions were prepared by kneading the components given in Table 1 in the proportions shown, for 5 minutes at 120° C. Next, a pair of polyethylene terephthalate film (“PET films” hereinafter) were prepared to dimensions of 1 m length, 15 cm width and 100 μm thickness, between which were sandwiched the compositions. The assemblies were then passed through a knife gap heated to 150° C. to shape them into 100 μm-thick film precursors. These film precursors were all colorless and transparent, with the exception of Comparative Example 3, which was colored yellow.

Next, an electron beam which had been accelerated at 200 kV was irradiated upon the film precursors at an absorption dose of 150 kGy, to yield film adhesives. These film adhesives were inserted into a commercially sold paper envelope and stored at approximately 25 to 27° C., then prepared for evaluation of flowability during heat-pressing, described infra evaluation of storage stability (in particular, differential scanning calorimetry (DSC)) and infrared spectrometry. Film adhesives were also fabricated by the film precursors to the electron irradiation at an absorption dose of 50 kGy, whereupon as described above, the film adhesives were inserted into commercially available paper envelopes and stored at 25 to 27° C. in preparation for their evaluation of flowability during heat-pressing.

TABLE 1

| | |
|---|---|
| Example 1 | CG5001/SI-145/γ-butyrolactone = 99/0.5/0.5 |
| Example 2 | CG5001/SI-150/γ-butyrolactone = 99/0.5/0.5 |
| Comparative Example 1 | CG5001/CI-2064 = 99/1 |
| Comparative Example 2 | CG5001/S-cat = 99.5/0.5 |
| Comparative Example 3 | CG5001/Irgacure ™ 261 = 99.5/0.5 |
| Comparative Example 4 | CG5001/KE-604 = 95/5 |

CG5001: ethylene-glycidyl methacrylate copolymer (Sumitomo Chemical Co (Ltd)); Bondfast; MFR = 350 g/10 min
SI-150: 4-acetoxyphenyl dimethylsulphonium hexafluoroantimonate (Sanshin Kagaku Kogyo (KK))
SI-145: 4-(methoxycarbonyl)oxy]benzenedimethyl-sulphonium hexafluoroantimonate (Sanshin Kagaku Kogyo (KK))
S-cat: triallylsulphonium hexafluoroantimonate (3M)
CI-2064: phenylmethyllaurylsulphonium hexafluoroantimonate (Nippon Soda Co, Ltd; 50% γ-butyrolactone solution)
Irgacure ™ 261: CpFeIsopropylbenzenePF6 (Ciba Specialty Chemicals)
KE-604: Rosin (Arakawa Kagaku Kogyo; acid value = 270 (mgKOH/g))
γ-butyrolactone: (Wako Junyaku KK)

### 2. Evaluation/Measurement of Film Adhesives

(1) Evaluation of Flowability During Heat-Pressing

As described above, the film adhesives were subjected to electron irradiation, and one week thereafter the heat-pressing, the flowability of the film adhesives of Examples 1 and 2 and Comparative Examples 1 through 4 were evaluated in the following manner. First, the film adhesives were cut into circles with a 6 mm diameter. Next, a glass plate (3 cm long, 2.5 cm wide, 1.1 mm thick) and a copper plate (3 cm long, 2.5 cm wide, 280 μm thick) were readied, and then heat-pressing bonded together via the circular film adhesives. The heat-pressing was carried out for 10 seconds at 180° C. at a pressure of 50 Newtons/cm². Once the heat-pressing step had finished, the diameters of the circular film adhesives were measured through the glass plate, and the flowability of the adhesives was calculated as per the formula below:

Flowability (%)=[diameter of circular film adhesive after heat-pressing (mm)/6 mm]×100

Table 2 displays the flowability of the compositions and film adhesives.

TABLE 2

| | 50 kGy | 150 kGy |
|---|---|---|
| Example 1 | 214 | 143 |
| Example 2 | 189 | 161 |
| Comparative Example 1 | NG | NG |
| Comparative Example 2 | NG | NG |
| Comparative Example 3 | NG | NG |
| Comparative Example 4 | 233 | 184 |

(unit: %)

The data in Table 2 illustrate that the flowability of the thermosetting adhesive of the present invention during heat-pressing can be easily controlled by electron irradiation.

According to Table 2, the adhesive composition of Comparative Examples 1 to 3 shows a flowability of not more than 120% with either electron irradiation and therefore do not provide an adhesive structure having sufficient adhesive power by heat pressing. As the result, the glass plate and copper plate were easily separated.

The adhesive composition of Comparative Example 4, however, has a flowability of more than 120%, and often shows oozing during heat-pressing when electron radiation dose is reduced to 50 kGy. Accordingly, the bonded structure obtained therefrom sometimes has poor appearance.

However, the adhesive compositions of Examples 1 and 2 show a flowability of more than 120 and can provide a bonded structure having high adhesive power by heat-pressing. In addition, the flowability not only effectively inhibits oozing, but when electron irradiation dose is reduced to 50 kGy for preventing foaming in the adhesive composition.

(2) Evaluation of Storage Stability

Next, the storage stability of the film adhesives was evaluated with regard to (i) change over time of heat reactivity following electron irradiation, (ii) change in strength of glycidyl peaks appearing in the infrared region and (iii) change in appearance.

(i) Change Over Time of Heat Reactivity Following Electron Irradiation

The heat reactivity of all film adhesives except Comparative Example 4 was evaluated both 1 day (24 hours) and 1 week after electron irradiation, and the change over time was determined according to the evaluation. The evaluation of heat reactivity was performed based on the peak temperature of the epoxy component crosslinking reaction and change in enthalpy. A DSC apparatus (Pyris-1; manufactured by Perkin-Elmer) was used to measure the peak temperature in the crosslinking reaction and the change in enthalpy, as the temperature of the film adhesives was raised from 40° C. to 300° C., in increments of 10° C. per minute. Table 3 displays the peak temperatures of the crosslinking reaction and the change in enthalpy per unitary mass (ΔH).

TABLE 3

| | After EB 1 day (within 24 hour) | | After EB 1 week | |
|---|---|---|---|---|
| | Peak Temp | | Peak Temp | |
| | [° C.] | ΔH [J/g] | [° C.] | ΔH [J/g] |
| Example 1 | 216 | −90 | 200 | −55 |
| Example 2 | 228 | −72 | 233 | −84 |
| Comparative | 157 | −79 | None | None |
| Example 1 | | | | |
| Comparative | 170 | −38 | None | None |
| Example 2 | | | | |
| Comparative | None | None | None | None |
| Example 3 | | | | |

(“None” refers to instances where the crosslinking peaks were too small to be determined)

The data in Table 3 reveal that the catalyst used in the present invention displayed outstanding heat curing reactivity, even one week after electron irradiation, in contrast to the structurally different catalysts. In other words, the data in Table 3 show that the compositions of Comparative Examples 1 through 3 could not be cured with heat one week after they had been subjected to electron irradiation. However, Examples 1 and 2, which were thermosetting adhesives of the present invention, showed a large ΔH value and also that they could undergo satisfactory heat curing, even one week after they had been subjected to electron irradiation. Accordingly, their heat curability is exceptional after electron irradiation, even during long-term storage.

(ii) Change in Strength of Glycidyl Peaks Appearing in the Infrared Region

Next, the infrared spectra of the film adhesives of Examples 1 and 2 and Comparative Example 1 were measured using a Fourier transform infrared spectroscope (model 1720-X; manufactured by Perkin-Elmer) based on attenuated total reflectance, frustrated internal reflectance and internal reflectance spectroscopy (ATR method), three days after having been subjected to electron irradiation. The reflected infrared spectra were also measured for each of the above compositions, without electron irradiation being performed.

The strength of the glycidyl peak in these spectra (911 cm⁻¹) was determined based on the absorption peak (720 cm⁻¹) derived from the polyethylene in the film adhesives and compositions, since the strength of the absorption peak derived from the polyethylene was virtually fixed prior and subsequent to electron irradiation.

(iii) Change in Sample Appearance During Storage

After observing the change in the film adhesives' appearance, it was confirmed that after having been stored as described in the above for just one week, the film adhesive of Comparative Example 3 was the only one to change from its original yellow colour and blacken as a result, while the other film adhesives exhibited virtually no change from their original colourless, transparent appearance.

Table 4 displays the relative peak strength after electron irradiation relative to the glycidyl group peak strength prior to electron irradiation, expressed as a percentage. According to the data in Table 4, the employment of the cationic polymerization catalyst used in the present invention, enables reductions in the resin glycidyl groups subsequent to electron irradiation to be controlled to a much greater degree than the differently structured catalysts. Accordingly, based on the flowability during heat-pressing, the preservability of heat curing reactivity and preservability of the residual glycidyl group absorption peaks, as described in the above, it is possible to conclude comprehensively that cationic polymerization reactions occur in the compositions of Comparative Examples 1 to 3 during storage. Therefore, their long-term storage stability is poor, and it is unlikely that a bonded structure can be obtained following long-term storage if they are not refrigerated. On the other hand, cationic polymerization reactions were prevented from occurring when Examples 1 and 2 of the present invention were placed in storage. It was also possible to store them at normal temperature (room temperature of 25° C. to 27° C.) and to obtain a good bonded structure during use.

TABLE 4

| | Three days after electron irradiation | |
|---|---|---|
| Example 1 | 96 | |
| Example 2 | 94 | |
| Comparative Example 1 | 0 | [None] |

(unit: %)
(“None” refers the glycidyl group peak being virtually extremely small)

(3) Elastic Modulus After Heat Curing

The film adhesives of Examples 1 and 2 and Comparative Example 4 were placed in an oven and cured by applying heat over two hours at 150° C., whereupon the elastic modulus of the cured articles was measured. The elastic modulus measurement was carried out using a dynamic viscoelastometer (RSAII; manufactured by Rheometrics). The elastic modulus of the cured articles at an angular velocity of 6.28 rad/sec was measured using a tensile method, while raising the temperature in increments of 10° C. per minute, from −70° C. to 300° C.

Table 5 displays the elastic moduli at 250° C. of the film adhesives of Examples 1 and 2 and Comparative Example 4 after the heat curing process.

TABLE 5

| | E′ [Pa] at 250° C. |
|---|---|
| Example 1 | 1.4 × 10⁷ |
| Example 2 | 1.4 × 10⁷ |
| Comparative Example 4 | 1.2 × 10⁶ |

According to Table 5, the adhesive compositions of Examples 1 and 2, in contrast to the composition of Comparative Example 4, clearly exhibited a marked increase in their elastic moduli after heat curing, even at high temperatures such as 250° C. An increase in their elastic modulus of such magnitude is highly advantageous in improving the solder heat resistance of the adhesive compositions during solder reflow.

### Merits of the Invention

No foul odor or discharged gas are produced during irradiation with the thermosetting adhesive of the present invention, nor are bubbles formed therein. Moreover, a high bonding property is exhibited, even with low-dose irradiation.

What is claimed is:

1. A thermosetting adhesive comprising an ethylene-glycidyl (meth)acrylate copolymer, formed from monomers comprising ethylene and glycidyl (meth)acrylate, and a cationic polymerization catalyst comprising a sulphonium salt expressed by the formula below 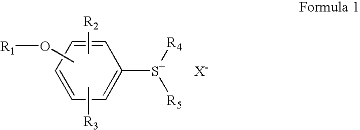
(wherein —OR₁ is present at 2, 4 or 6 position of the phenyl group, R₁ represents an acetyl group, a methoxycarbonyl group, an ethoxycarbonyl group, a benzyloxycarbonyl group, a benzoyl group, a phenoxycarbonyl group, a p-methoxybenzyloxycarbonyl group or a 9-fluorenylmethoxycarbonyl group; R₂ and R₃ independently show hydrogen, halogen or an alkyl group having 1 to 4 carbon atoms; R₄ and R₅ independently show an alkyl group having 1 to 4 carbon atoms, and X⁻ shows a non-nucleophilic anion).

2. The thermosetting adhesive according to claim 1, wherein the cationic polymerization catalyst is present in an amount of 0.001 to 1 wt %.

3. The thermosetting adhesive according to claim 1, wherein the ethylene-glycidyl (meth)acrylate copolymer has a melt flow rate of at least 1 g/10 min and the cationic polymerization catalyst is 4-[(methoxycarbonyl)oxy]benzenedimethylsulfonium hexafluoroantimonate.

4. A film adhesive comprising a substrate and a coating layer formed thereon from the thermosetting adhesive according to claim 1 or 2.
